(19) United States
(12) Patent Application Publication
(10) Pub. No.: US 2004/0006750 A1
(43) Pub. Date: Jan. 8, 2004

(54) Method for min-cut and ratio min-cut partitioning

(76) Inventors: Kuo-Hsing Cheng, Taipei (TW); Shun-Wen Cheng, Taipei (TW)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/612,775

(22) Filed: Jul. 2, 2003

Related U.S. Application Data
(62) Division of application No. 09/765,921, filed on Jan. 19, 2001.

(51) Int. Cl. G06F 17/50

(52) U.S. Cl. 716/3

(57) ABSTRACT

The method of Edge-Node Interleave Sort for Leaching and Envelop (ENISLE) comprises mapping a circuit into a V-E plain to transform a circuit information into V-E plain. A plurality of sorting is performed for obtaining min-cut or/and ratio min-cut partitioning. The sorting includes (1) performing a first sorting step from an edge view based on a bottom side of the V-E plain; (2) performing a second sorting step from an node view based on a right side of the V-E plain; (3) performing a third sorting from said edge view based on a top side of the V-E plain; and (4) performing a fourth sorting step from said node view based on a left side of the V-E plain.

### FIELD OF THE INVENTION

The present invention relates to a method for min-cut and ratio min-cut partitioning, and more specifically, to an optimal and intuitive heuristic optimal method for the min-cut partitioning.

### BACKGROUND OF THE INVENTION

The large integration of semiconductor ICs has been accomplished by a reduction in individual device size. With this reduction of device size, many challenges arise in the manufacture of the integrated circuits. The integrated circuits typically include a great numbers of electronic components fabricated by multi-layer with several different materials on a wafer. The IC design includes the technique of circuit design to create a schematic design having a desired circuit. An actual device is produced to perform the function described in the schematic design. The transformation from the circuit description into a geometric description is referred to a layout. A layout consists of a set of planar geometric shapes in several layers.

The purpose of the layout procedure is to construct a device, which reduced the area of the layout area and signal propagation delays between associated logic elements. Thus, the desired layout area and the signal propagation delays between elements are considered in the configuration of the element locations. The routing is the formation of an interconnection network connecting associated elements of the circuit design.

Circuit partitioning plays a key role in the field of chip design, multi-chip system and system-on-chip (SOC). It is used to reduce VLSI chip area, reduce the component count and the number of interconnections in multiple FPGA implementations of large circuits or system. It facilitates efficient parallel simulation of circuits, facilitates design of tests for digital circuits and reduces timing delays, and facilitates the various combination of sub-system layouts. The circuit partitioning methods includes a goal of minimizing the number of nodes that connect sub-circuits. Up to now, the circuit simulation is executed using a computer system so that the circuit exhibits the desired performance. In general, VLSI design needs computer-aided design tools to perform the partitioning. Parallel simulation of circuit is efficient to facilitate design of test. To take effort in circuit simulation with efficiency, simulation systems that partition a target system into a plurality of sub-circuits for parallel simulation. In such simulation systems, the partitioning method for the target circuit significantly effects the accuracy and the speed required for computations Some of the prior arts may refer to Naveed. A. Sherwani, (Intel Corp.), Chapter 5: Partitioning, Algorithms for VLSI Physical Design Automation. 3rd Ed., Boston, Mass.: Kluwer Academic Publishers, 1999., and other references.

However, all of art skills are too complicated and inefficiency. For example, most partitioning methods for circuit netlists like Fiduccia-Mattheyses (FM) method computes the gains of nodes using local netlist information. It only concerns the immediate improvement in the cutest.

What is needed is to provide a method that involves the usage of not only the node information but also the edge information.

### OTHER REFERENCES

[1] S. B. Akers, “Clustering Techniques for VLSI,” in Proc. IEEE Int. Symp. on Circuits and Systems, 1982, pp. 472476.

[2] C. J. Alpert, J.-H. Huang, and A. B. Kahng, “Multilevel circuit partitioning,” in Proc. Design Automation Conf., 1997, pp. 530-533.

[3] C. J. Alpert and S.-Z. Yao, “Spectral partitioning: The more eigen-vectors the better,” in Proc. Design Automation Conf., 1995, pp. 195-200.

[4] J. Cong et al., “Large scale circuit partitioning with loose/stable net removal and signal flow based clustering,” in Proc. IEEE/A CM Int. Conf. Computer-Aided Design, November 1997, pp. 441-446.

[5] J. Cong and S. K. Lim, “Multiway Partitioning with Pairwise Movement,” in Proc. Int. Conf. Computer-Aided Design, 1998, pp. 512-516.

[6] S. Dutt and W. Deng, “A probability-based approach to VLSI circuit partitioning,” in Proc. IEEE/ACM Design Automation Conf., June 1996, Best-Paper Award, pp. 100-105.

[7] S. Dutt, “New faster Kernighan-Lin-type graph-partitioning algo-rithms,” in Proc. IEEE/A CM Int. Conf. Computer-Aided Design, November 1993.

[8] C. M. Fiduccia and R. M. Mattheyses, “A linear-time heuristic for improving network partitions,” in Proc. IEEE/ACM 19th Design Automation Conf., 1982, pp. 175-181.

[9] J. Garbers, H. J. Promel, and A. Steger, “Finding clusters in VLSI circuits,” in Proc. IEEE/ACM Int. Conf Computer-Aided Design, 1990, pp. 520-523.

[10] M. R. Garey and D. S. Johnson, Computers and Intractability. San Francisco, Calif.: W. H. Freeman, pp. 209-210.

[11] L. Hagen and A. Kahng, “Fast spectral methods for ratio cut partitioning and clustering,” in Proc. IEEE/ACM Int. Conf. Computer-Aided Design, 1991, pp.10-13.

[12]M. A. B. Jackson, A. Srinivasan, and E. S. Kuh, “A fast algorithm for performance driven placement,” in Proc. IEEE/ACM Int. Conf. Computer Aided Design, 1990, pp. 328-331.

[13] B. W. Kemighan and S. Lin, “An efficient heuristic procedure for partitioning graphs,” Bell System Tech. Journal, vol. 49, pp. 291-307, February 1970.

[14] D. E. Knuth, Sorting and Searching. Addison-Wesley, 1973.

[15] B. Krishnamurthy, “An improved min-cut algorithm for partitioning VLSI networks,” IEEE Trans. Computers, vol. C-33, pp. 438-446, May 1984.

[16] Y. G. Saab, “A fast and robust network bisection algorithm,” IEEE Trans. Computers, pp. 903-913, 1995.

[17] C. Sechen, VLSI Placement and Global Routing Using Simulated Annealing, B. V. Deventer, Ed. Amsterdam, Netherlands: Kluwer.

[18] N. A. Sherwani, Algorithms for VLSI Physical Design Automation. 3rd Ed., Boston, Mass.: Kluwer, 1999.

[19] Y. C. Wei and C. K. Cheng, “An improved two-way partitioning algorithm with stable performance,” IEEE Trans. Computer-Aided Design, pp. 1502-1511, 1990.

[20] Y. C. Wei and C. K. Cheng, “Toward efficient hierarchical designs by ratio cut partitioning,” in Proc. Int. Conf. Computer-Aided Design, 1989, pp.298-301.

### SUMMARY OF THE INVENTION

An object of the present invention is to provide a method of min-cut and ratio min-cut partitioning. The present invention discloses a new method ENISLE for min-cut partitioning. The method includes one step of mapping the circuit into a V-E plain and steps of sorting the V-E pairs contained on the V-E plain. The ENISLE is a novel method rather than an improved or modified min-cut partitioning. The proposed method is not only using node information but also edge information. The (V, E) pairs may approach to uniformly distribution on the V-E plain, thereby obtaining the optimal solution.

The method of Edge-Node Interleave Sort for Leaching and Envelop (ENISLE) comprises mapping a circuit into a V-E plain to transform a circuit information into V-E plain. The V-E plain contains the information of node and edge information, wherein V indicates nodes that represent components of said circuit and wherein E indicates edges that represents the nets of the circuits. Then, a next step is to determine whether (V, E) pairs distribution on the V-E plain is uniformly or not? If (V, E) pairs distribution approaches to non-uniformly distribution, then randomizing the (V, E) pairs on the V-E plain, otherwise performing following steps for sequentially arranging allocations of the V-E pairs according to the magnitude of each said node or said edge, thereby obtaining min-cut or/and ratio min-cut partitioning.

(1) Performing a first sorting step from an edge view based on a first side of the V-E plain;

(2) Performing a second sorting step from an node view based on a second side of the V-E plain;

(3) Performing a third sorting from said edge view based on a third side of the V-E plain; and

(4) Performing a fourth sorting step from said node view based on a fourth side of the V-E plain.

### BRIEF DESCRIPTION OF THE DRAWINGS

FIG. 1 is a diagram of the goal of the min-cut partitioning.

FIG. 2 is a diagram of the goal of the ratio min-cut partitioning.

FIG. 3 shows that the circuit is numbered from back-end (output) to front-end (input) in sequence.

FIG. 4 shows that the circuit is numbered from front-end (input) to back-end (output) in sequence.

FIG. 5 shows that the (V, E) pairs of FIG. 4 numbered circuit display on the V-E plain.

FIG. 6 illustrates some special (V, E) distribution cases.

FIG. 7 shows a modified common multiplicative congruential random number series generator (ANSI C program).

FIG. 8A shows that interleave cutting the IC circuit can get an initial nearly max-cut partitioning status.

FIG. 8B separately randomizes the two part nodes in FIG. 8A.

FIG. 9 shows the ENISLE steps including a initialize step, and/or a randomize step, basic phase one sorting and different additional sorting phases.

FIGS. 10A-10F separately show the example of the detailed basic steps of the ENISLE according to the present invention.

FIG. 11 shows the example of the completely basic steps of the ENISLE according to the present invention.

FIG. 12 is a flow chart diagram according to the present invention type 2A.

FIG. 13 shows the usage of bit field structure, it effectively reduce the memory requirement.

FIG. 14 shows the usage of radix sorting.

FIGS. 15A-15F show an alternative example that effectively solved the mincut and ratio-mincut partitioning at the same time by the present ENISLE.

FIG. 16 shows another successful examples solved by the present ENISLE.

FIGS. 17A-17C show some useful data display compression techniques.

FIG. 18 shows the processes of the example in FIG. 15 by display compression representation in FIG. 17A.

FIG. 19 shows a non-uniformly distributed condition.

FIGS. 20A-20C shows the relationship between cut numbers and the initial (V, E) pairs distributed condition/entropy.

### DETAILED DESCRIPTION OF THE PREFERRED EMBODIMENT

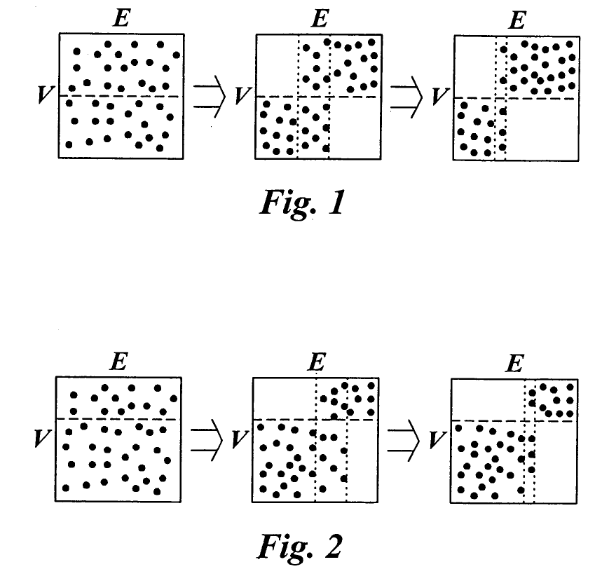

The present invention discloses a method of min-cut and ratio min-cut partitioning. To solve the problems mentioned above, the description of the preferred embodiments of this invention has diagrams shown in FIGS. 1-2. FIGS. 1 and 2 are diagrams explaining the theory of the embodiment of this invention. The principle of the present invention is to transform a circuit into a hyper-graph or netlist G=(V, E) which contains the information of node and edge information. Wherein V indicates the set of nodes that represent components of the circuit and E is the set of hyperedge that represents the nets of the circuits. Each hyperedge or net connects two or more nodes, in general; the output of a node is connected to the inputs of a plurality of other nodes by anet.

In FIG. 1, the diagram indicates min-cut partitioning whereas FIG. 2 represents the ratio min-cut partitioning. It has to be noted that when (V, E) pairs approach to uniformly distribution on the V-E plain, if the min-cut state is found, the “out-line area” Will from VE approach to VE/2, it is similar to the vapor compression behavior.

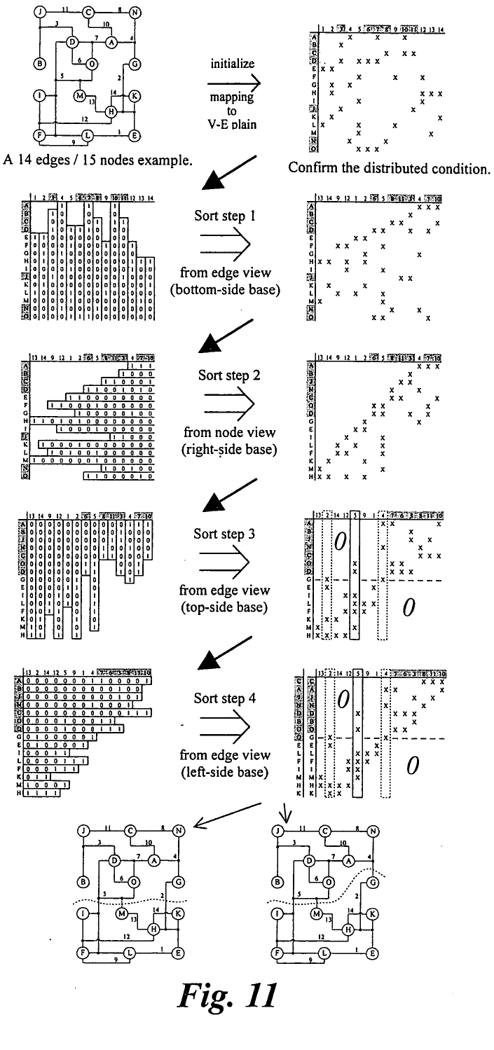

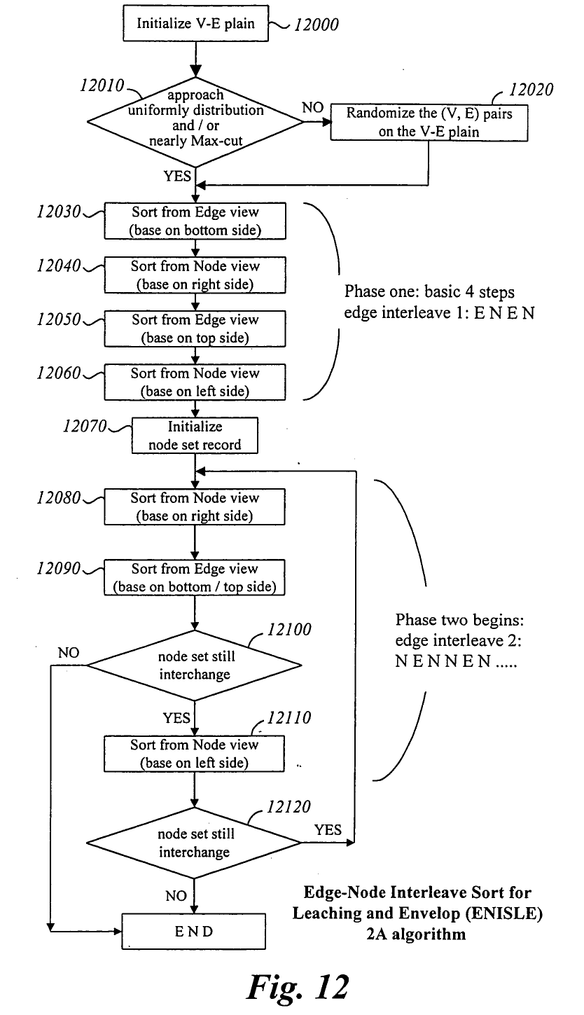

The proposed method is referred to Edge-Node Interleave Sort for Leaching and Envelop (ENISLE) algorithm, the present method itself comprises following major steps. Please turn to FIG. 12, the first step 12100 is to transform or map a circuit into a (V, E) plain, or refer to initialize V-E plain. The circuit information is transformed into a hyper-graph or netlist G=(V, E) which contains the information of node and edge information. The V-E plain includes a matrix having column and row information. For example, the column includes the edge information, while the row includes the node information, which constructs the V-E pairs. It is appreciated that the parameters indicated the column and row might be interchanged.

The Description of (V, E) pairs on the V-E plain is shown as follows, a circuit is used as an example rather than limiting the present invention:

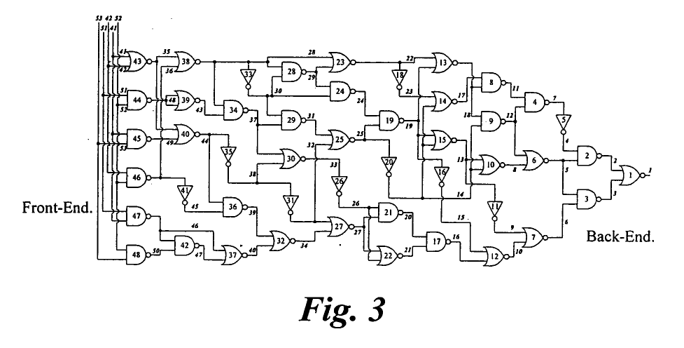

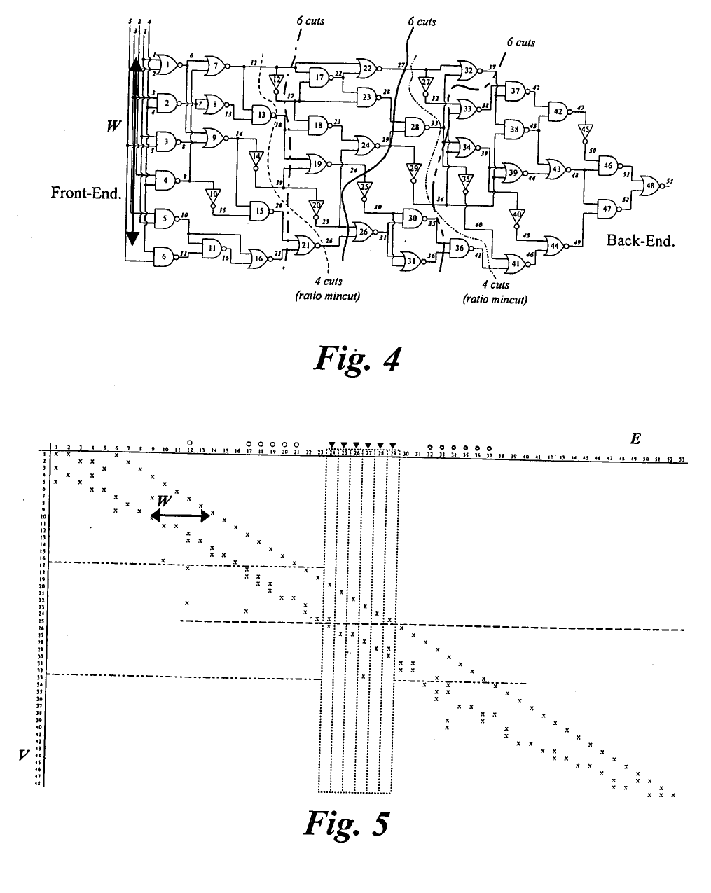

The circuit in FIG. 3 is the same with the FIG. 4. It is composed of simple 2-input NOR gate, 2-input NAND gate and inverter gate only, every node (gate) connect 2-3 edges (pins), no more complex function blocks. FIG. 3 shows the nodes and edges of the circuit were numbered from back-end (output) to front-end (input) in sequence. On the contrary, FIG. 4 shows the nodes and edges of the circuit were numbered from front-end (input) to backend (output) in sequence. Due to VLSI circuits are hyper-graph, compound tree-based structures, or like the forest, the circuits were also numbered by depth first search (DFS) style or Breadth First Search (BFS) style.

The (V, E) pairs of FIG. 4 numbered circuit display on V-E plain are shown in FIG. 5. Because numbered the circuit in sequence, it diagonally distributed on the V-E plain, like a narrow leaf. The width W of the “leaf” on the V-E plain, is in proportion to the “width” of the circuit. The width W times the levels of the circuit (tree), are approximately equal to the size (node) of the circuit.

In general cases, the larger the nodes, the larger the edges. Due to this circuit is simple and small, it can be directly observe the V-E plain without any further processes, to find the bi-part cuts are 6 cuts, and the ratio tri-part cuts are 6 cuts. Although the min-cuts are 5 cuts, and ratio min-cuts are 4 cuts, the 6 cuts answer is enough good for industrial usages. If you use other min-cut methods, you may waste time to do meaningless minor improvements.

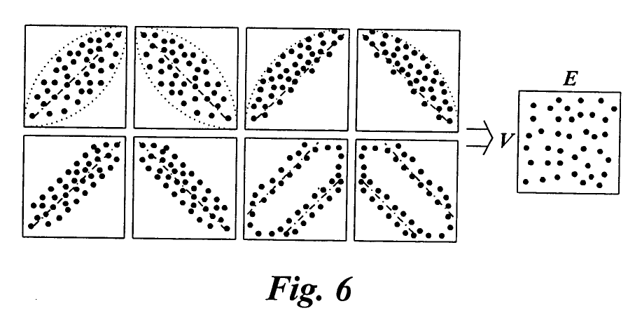

FIG. 6 shows some special (V, E) distribution cases, namely, nonuniformly distribution. It often is seen when describe the row-based placement in sequence. The “outline area” of (V, E) pairs occupied on the V-E plain is far less than VE. The characteristic is unlike the vapor compression behavior, on the converse, like “melting” the material. Therefore, “heating” may be necessary to add “entropy” to it. Further, these cases ease to resolve the blocks and some small blocks will be automatically resolved in the proposed method.

Common Quasi-Random Case

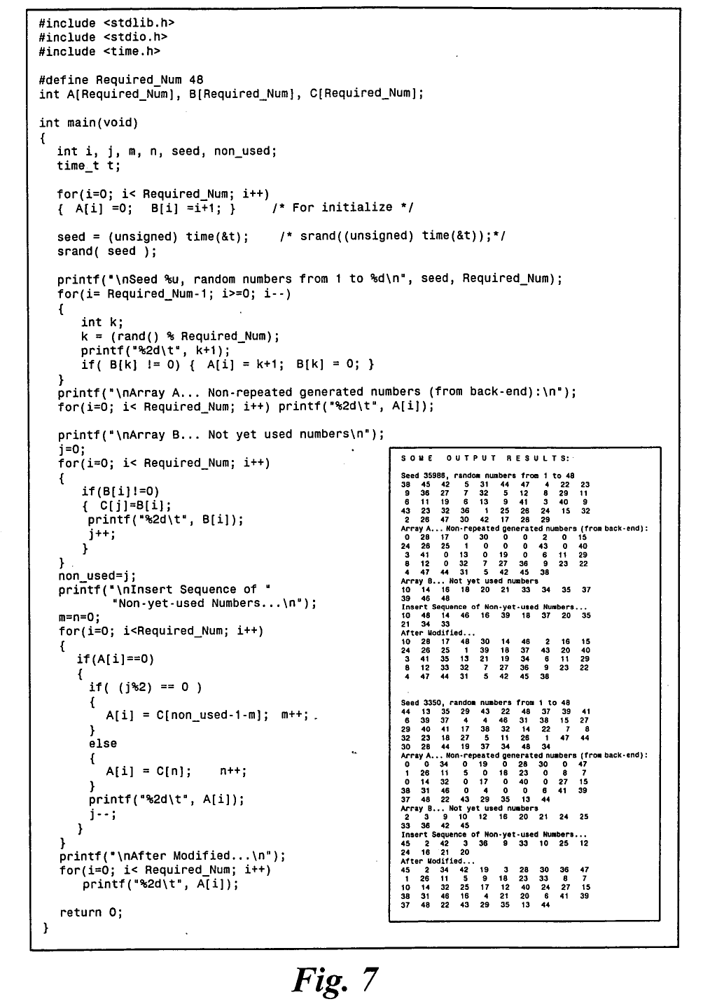

The example of ANSI C function rand in FIG. 7 uses a common low-end multiplicative congruential random number generator (ex. Borland C++ Compiler, 1992 DOS version) with period 2³² to return successive pseudo-random numbers in the range from 0 to 2^{15;} this means it can handle a 2¹⁵ (32,768) node-size circuit under this compiler. After suitable modification, a quasi-random number series without repeated-present numbers are generated.

The Quasi-Random Case Under Nearly Max-Cut Reservation

Hypergraphs are systems of sets which are conceived as natural extensions of graphs: elements correspond to nodes, sets correspond to edges which are allowed to connect more than two nodes. Hypergraphs are typical compound tree-based structures. The same level nodes in tree-based structures do not connect each other. In other words, this means the nodes between same levels have no edges.

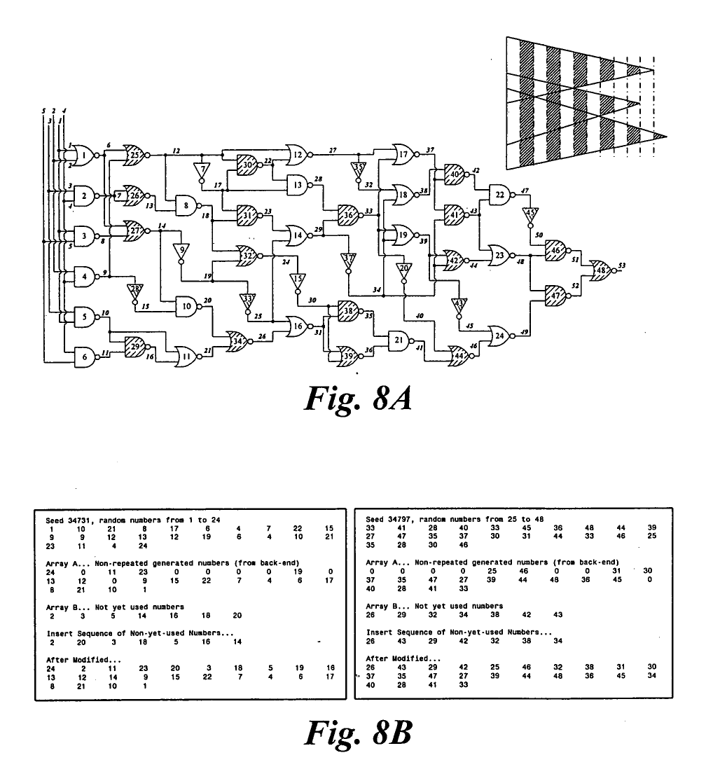

Quickly rough divide VLSI circuits into two parts, one part mainly contains odd-level nodes, another part mainly contains even-level nodes. By this interleave cutting concept, due to the nodes between the same level have no edges, we get a nearly max-cut partitioning of the VLSI circuit. The example is shown as FIG. 8A. Then separately randomize the order of these two part nodes as shown in FIG. 8B. This method has several advantages: we force the initial stage not only in higher entropy but also hold the nearly max-cut reservation. We consider this lead the higher converge speed. The following sections are adopted by this improved method.

ENISLE:

Edge Node Interleave Sort for Leaching and Envelop

The next step 12010 in FIG. 12, determining whether (V, E) pairs distribution is uniformly or not. If the distribution approaches to nonuniformly distribution, then randomize the (V, E) pairs on the V-E plain in step 12020.

On the contrary, the distribution approaches to uniformly distribution, a phase one procedure or edge interleave 1 is performed for sequentially arranging allocations of the V-E pairs according to the magnitude of each node or edge information, thereby obtaining min-cut or/and ratio min-cut partitioning. The phase one including the steps of:

(1) Performing a first sorting step (12030) from the edge view based on a first side, preferably, the bottom side of the V-E plain;

(2) Performing a second sorting step (12040) from the node view based on a second side, preferably, the right side of the V-E plain; The aforementioned two steps may set the upper triangle area that contains almost no data therein.

(3) Performing a third sorting step (12050) from the edge view based on a third side, preferably, the top side of the V-E plain;

(4) Performing a fourth sorting step (12060) from the node view based on a fourth side, preferably, the left side of the V-E plain.

Similarly, the lower triangle area also contains almost no data therein. It is appreciated that almost all of the information gathers adjacent to the diagonal line of the V-E matrix or the V-E plain.

The above phase one procedure includes four sorting steps, called edge interleave step: ENEN, the step may obtain the cutting configuration.

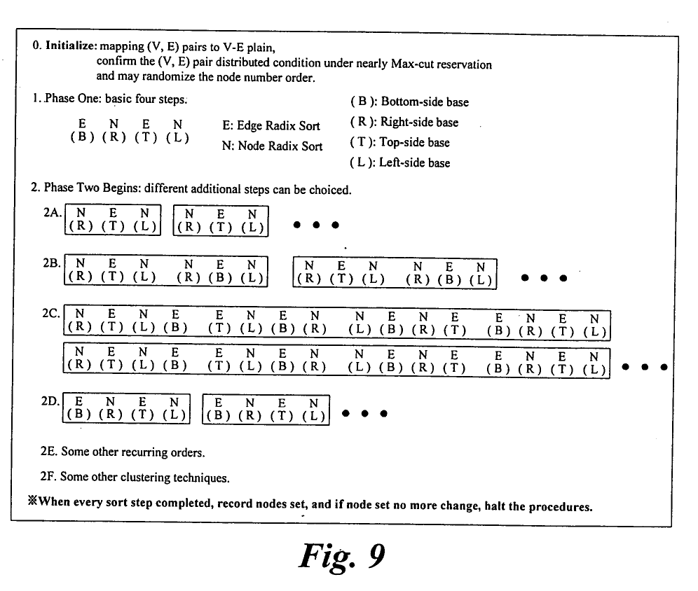

The subsequent step 12070 is to initialize the node set record. FIG. 9 shows the steps including phase one sorting and different additional sorting phases. As shown in the diagram, the additional sorting phase includes a plurality of sorting modes comprising recurring order type 2A: N(R) E(T) N(L), type 2B: N(R) E(T) N(L) N(R) E(B) N(L), type 2C: N(R) E(T) N(L) E(B) E(T) N(L) E(B) N(R) N(L) E(B) N(R) E(T) E(B) N(R) E(T) N(L), type 2D: E(B) N(R) E(T) N(L), and some other recurring order, some other clustering techniques. Each type all can get similar results, approach to mincut solution

FIG. 12 uses the type 2A as an example, it is appreciated that other type can be used. In step 12080, a fifth sorting step is used from the node view based on the second side, followed by performing a sixth sorting step (12090) from the edge view based on the first side/third side. The next step 12100 is to determine whether the node set is still interchanged or not? If the node set is no longer interchange then go to the end. Otherwise, a further sorting step is performed from the node view based on the fourth side, step 12110. In step 12120, it is determined whether the node set still interchange or not. If the node set is still interchange, then step 12080 is performed again. On the converse, an optimal min-cut or/and ratio min-cut partitioning is obtained.

It has to be noted that the present embodiment can intuitive determine distributed uniformly or not by the final diagram clearly, additional computing about correlation coefficients or co-variances is not necessary. Suppose that the (V, E) pairs are not uniformly distributed on V-E plain, and if it is not randomized, the directly issue the converge procedures and we may get a worse cut solution and leave the loop. No non-determined/infinite loops occur.

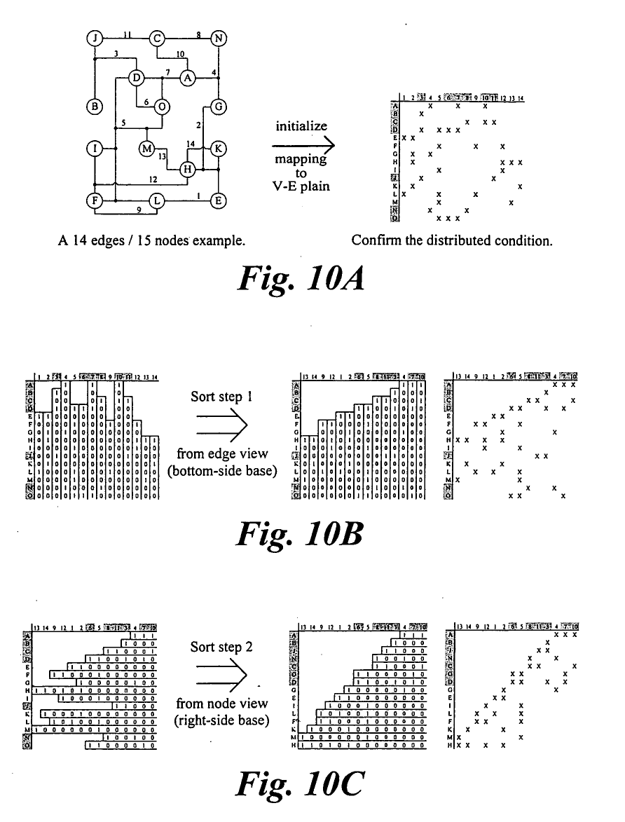

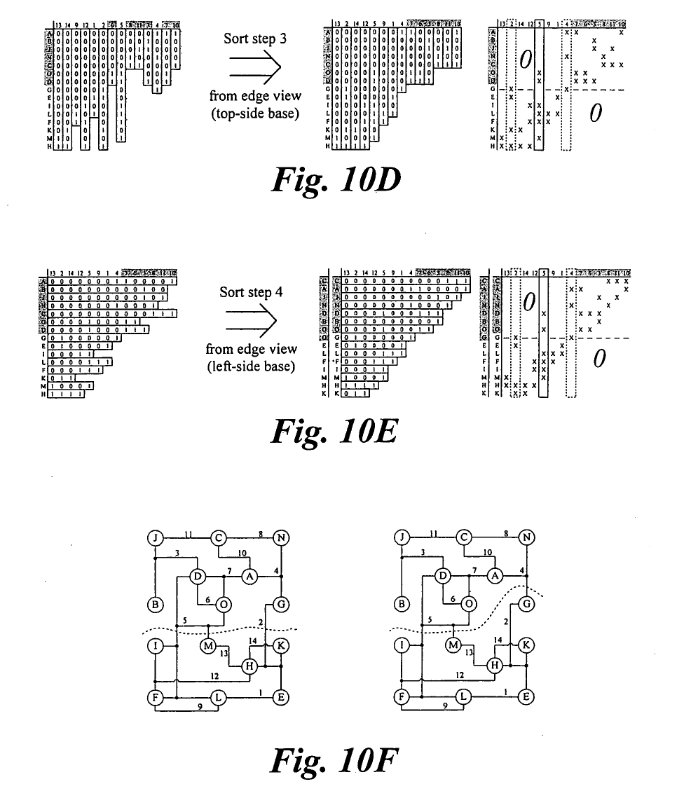

FIGS. 10A-10F shows an example of the phase one steps according to the present invention, referred to ENISLE algorithm. It indicates that we may soon obtain the min-cut solution. It is appreciated that the embodiments of the present invention are illustrated of the present invention rather than limiting of the present invention.

Turning to FIG. 10A, it illustrates an example of a circuit having 14 edges and 15 nodes. An initialize step is performed for mapping the circuit information into a V-E plain, as shown in FIG. 10B. The hyper-graph or netlist G=(V, E) contains the information of node and edge information. Each hyperedge or net connects two or more nodes, the relationship of the nodes are shown in the hyper-graph.

FIG. 10B illustrates the result after the first sorting from edge view based on the bottom side based on the bottom edge. It sequentially arranges the allocation of the V-E pairs according to the magnitude from high to low or low to high.

The sorted V-E plain may be presented as FIG. 10C from the node view based on the right side. Therefore, after the sorting from the right side is illustrated on the right part in FIG. 10C. The V-E pairs are also arranged according to the magnitude of each node or edge based on the right side.

A sorting step from the node view based on the top side is performed and illustrated in FIG. 10D and the relocation result is shown on the right part in FIG. 10D.

Similarly, the last sorting step is illustrated in FIG. 10E, which is from the node view based on the left side. Next, the V-E pairs are allocation sequentially according to the magnitude or valve from high to low. The result is schemed on the right part in FIG. 10E. We may find the optimal min-cut solution via the FIG. 10E. The V-E pairs may re-transformation or re-mapping to a min-cut or ratio min-cut partitioning circuit. The circuits may be seen in FIG. 10F. The total steps in FIGS. 10A-F are completely shown in FIG. 11.

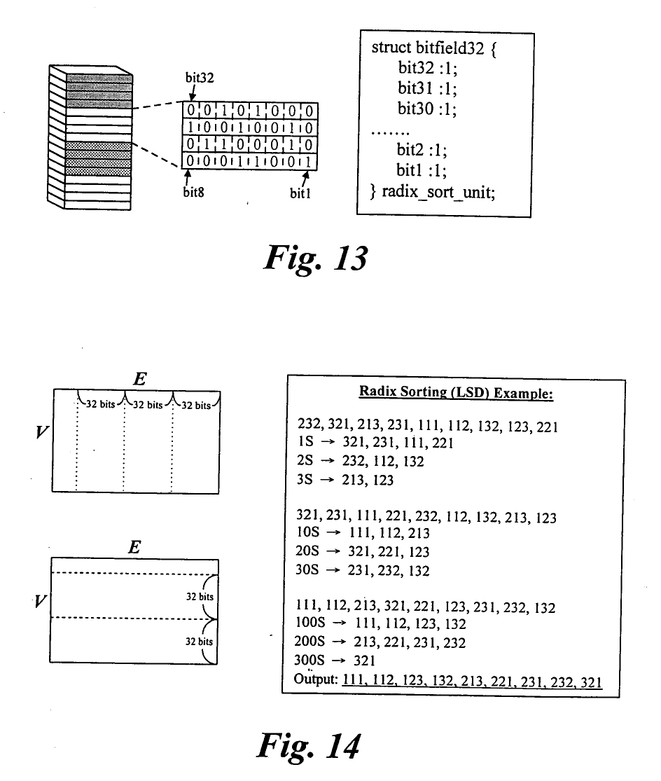

In the ENISLE algorithm, carefully arrange memory requirement is necessary. As shown in FIG. 13, the usage of bit field structure reduces to one-eighth-memory space. If it has 100K nodes and 550K edges, the program will need about 6.4 GB virtual memory space. A powerful sorting engine decides the performance of the method—we need sort very mass numbers!. Using radix sort may handle this problem effectively, as shown in FIG. 14. If the circuit is more enormous, multi-level methods may be considered. The radix sort may refer to D. E. Knuth, Sorting and Searching. Addison-Wesley, 1973 and the multi-level methods may refer to C. J. Alpert, J. H. Huang, and A. B. Kahng, “Multilevel circuit partitioning,” in Proc. Design Automation Conf., 1997, pp. 530-533.

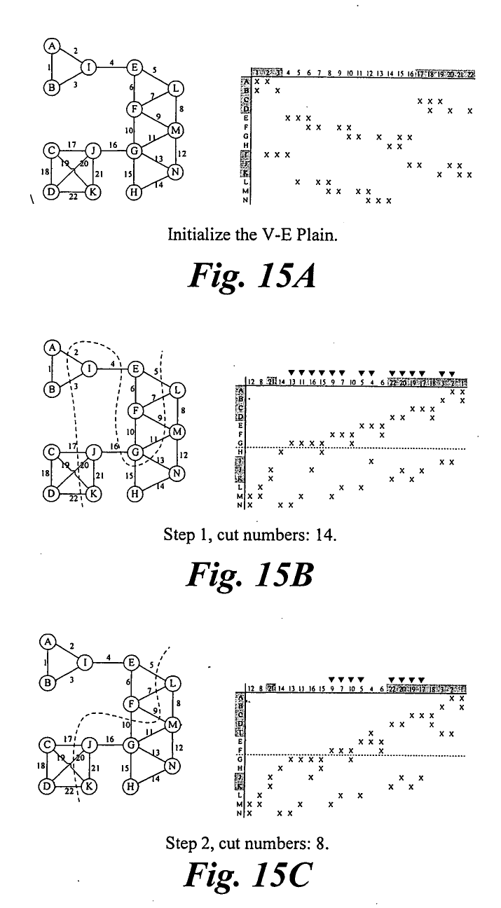

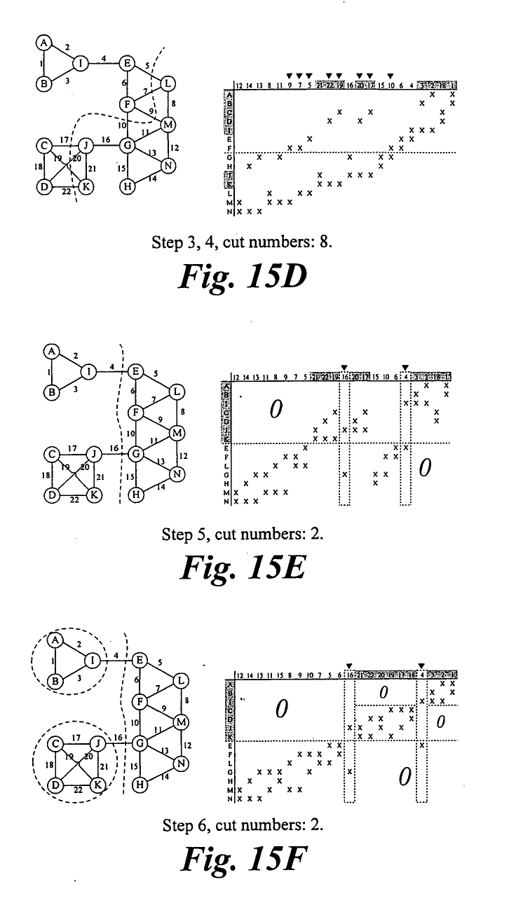

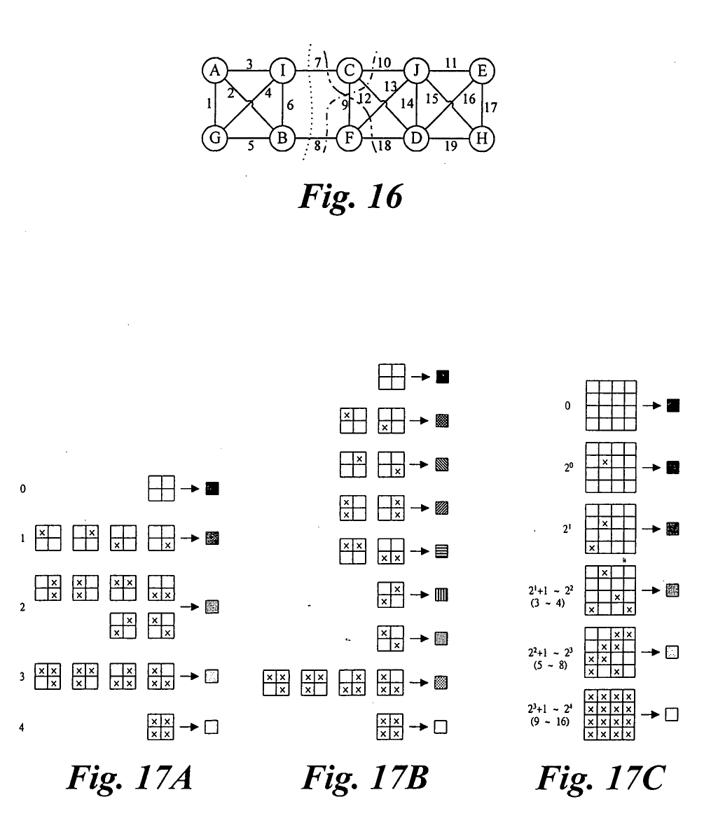

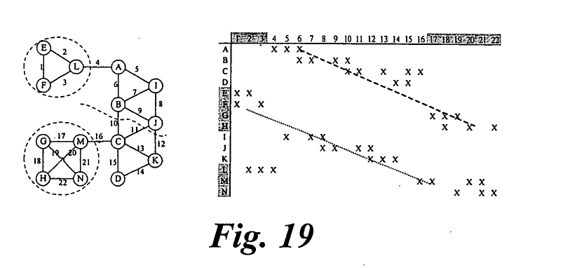

FIGS. 15A-15F show an alternative example solved by the present ENISLE. The method is similar to the last embodiment, thereby omitting the detail description herein. Apparently, the ENISLE effectively solves the mincut and the ratio min-cut partitioning at the same time. FIGS. 16 and 19 further show successful examples solved by the present ENISLE. In FIG. 19, the V-E pairs are not uniformly distributed on V-E plain. If the randomizing step is not carried out, it then directly issue the converge procedure. It shows that the optimal solution (2 cuts) can not be obtained, but get a nearly optimal solution (3 cuts). It can intuitively determine distributed uniformly or not by the diagram clearly.

(V! E) Pairs Display and Representation

Originally Display (V, E) Pairs on a V-E Plain

We can scroll the screen, like scroll a spreadsheet to observe the (V, E) pairs distributed condition.

Display Data Compression

Display Compression by Different Colors

For example, on a 1280×1024 pixels×24 bits true color display monitor, assume 1280×16 bits edges/1024×8 bits nodes=20480 edges/8192 nodes per screen, or 1024×24 bits edges/1280 bits nodes=24576 edges/1280 nodes per screen.

Display Compression by Different Light Intensity and/or Different Patterns on a Monochrome Viewpoint

Some useful data compression technique examples are shown in FIGS. 17A-17C. Let L nodes×W edges (V, E) pairs rectangle region (if L=W, this is a square) compose a block. The more (V, E) pairs in the block, the higher light intensity. If no (V, E) pair in the block, it is thick darkness.

Several other color quantities like hue, saturation, brightness, tints, tones, shades, and luminance also can be adopted to represent the amount of the (V, E) pairs in a block.

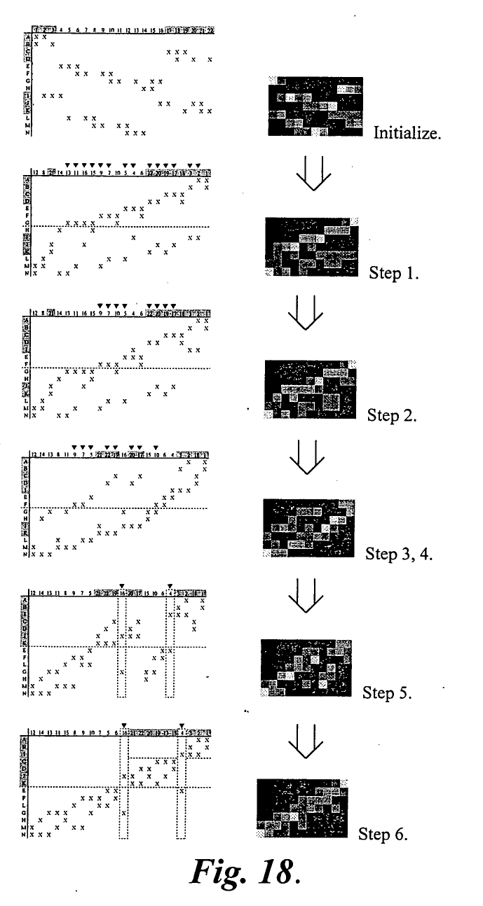

Although display compression lead to miss the exact display positions of (V, E) pairs, just only display it in a block, but we can watch more larger size V-E plain or the whole V-E plain in a monitor screen. And in fact the exact (V, E) pairs positions still be held. So we can zoom in the V-E plain to watch detail local (V, E) pairs distributed condition, or zoom out to watch global (V, E) pairs distributed condition. The processes of the example in FIGS. 15A-F demonstrate by display compression FIG. 17A representations are shown in FIG. 18.

The above methods all can directly be observed every iterative improvement, get useful information, or decide to manually halt the procedures or not, if necessary. This is suitable for IC industrial EDA certain cuts constraint under non-uniformly distributed case.

A method for display data compression techniques by different light intensity and/or different patterns on a monochrome viewpoint, comprising:

displaying (V, E) pairs on an initial V-E plain shown on a monitor screen to observe the the initial (V, E) pairs distributed condition, wherein the V indicates nodes that represent components of the circuit and wherein the E indicates edges that represents the nets of the circuits;

setting L nodes×W edges (V, E) pairs rectangle region to compose a block, wherein the L and W are integers;

defining the more (V, E) pairs in the block to be displayed by the relatively high light intensity to the less (V, E) pairs in the block; and

watching relatively large size of V-E plain or a whole V-E plain to the initial (V, E) plain on the monitor screen, wherein the exact (V, E) pairs positions still be held, thereby zooming in the V-E plain to watch detail local (V, E) pairs distributed condition, or zooming out to watch global (V, E) pairs distributed condition on the monitor screen.

Therefore, the present invention provides a method for display data compression techniques by different light intensity and/or different patterns on a monochrome viewpoint, comprising:

displaying (V, E) pairs on an initial v-e plain shown on a monitor screen to observe the the initial (V, E) pairs distributed condition, wherein the v indicates nodes that represent components of the circuit and wherein the E indicates edges that represents the nets of the circuits;

setting L nodes×W edges (V, E) pairs rectangle region to compose a block, wherein the L and W are integers;

defining the less (V, E) pairs in the block to be displayed by the relatively high light intensity to the more (V, E) pairs in the block; and

watching relatively large size of V-E plain or a whole V-E plain to the initial (V, E) plain on the monitor screen, wherein the exact (V, E) pairs positions still be held, thereby zooming in the V-E plain to watch detail local (V, E) pairs distributed condition, or zooming out to watch global (V, E) pairs distributed condition on the monitor screen:

The alternative embodiment according to the display data compression techniques by different light intensity and/or different patterns on a monochrome viewpoint may define the less (V, E) pairs in the block to be displayed by the relatively high light intensity to the more (V, E) pairs in the block Alternatively, the present invention provides a further method for display data compression techniques by different color and/or different patterns on a monochrome viewpoint, comprising:

displaying (V, E) pairs on an initial V-E plain shown on a monitor screen to observe the the initial (V, E) pairs distributed condition, wherein the V indicates nodes that represent components of the circuit and wherein the E indicates edges that represents the nets of the circuits;

setting L nodes×W edges (V, E) pairs rectangle region to compose a block, wherein the L and W are integers;

defining the more (V, E) pairs in the block to be displayed by the relatively bright color to the less (V, E) pairs in the block; and watching relatively large size of V-E plain or a whole V-E plain to the initial (V, E) plain on the monitor screen, wherein the exact (V, E) pairs positions still be held, thereby zooming in the V-E plain to watch detail local (V, E) pairs distributed condition, or zooming out to watch global (V, E) pairs distributed condition on the monitor screen.

Alternatively, the above method for display data compression techniques may define the less (V, E) pairs in the block to be displayed by the relatively bright color to the more (V, E) pairs in the block is stead of aforementioned definition.

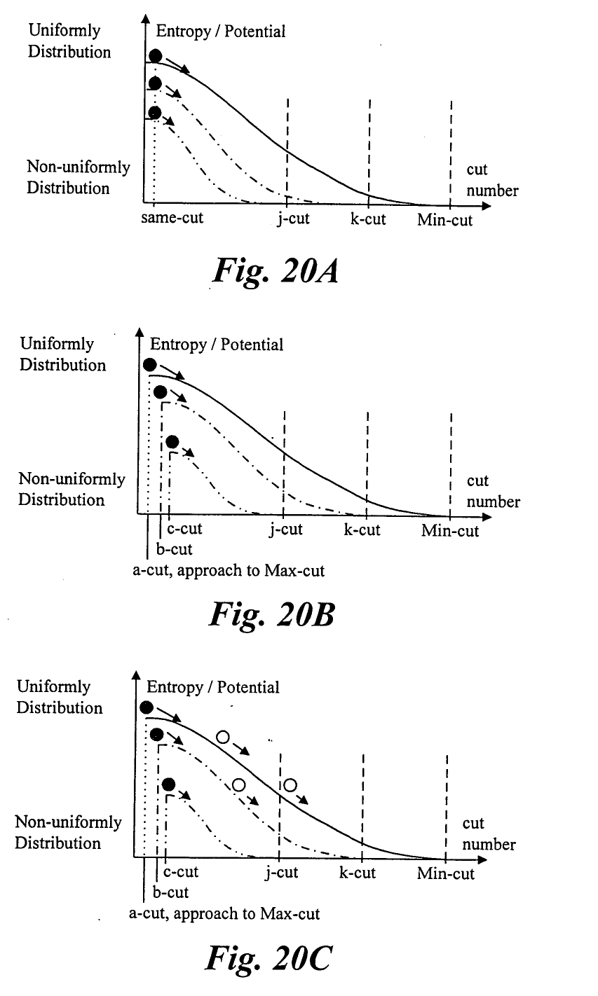

As mentioned in FIG. 6, it shows (V, E) pairs non-uniformly distributed lead the probability that we can get the min-cut solution is relatively small. The work finds the relationship between cut numbers and initial (V, E) pairs distributed condition/entropy is a very important issue. And if the cuts of the higher initial (V, E) pairs distributed potential/entropy approach to max-cuts, or under nearly the max-cut reservation, has higher probability to aim min-cut. It is as shown as FIG. 20A, FIG. 20B and FIG. 20C, the relationship between cut number and initial (V E) pairs distributed condition/entropy. The cut number j>k>min-cut, k is the second optimal cut and the j is the third optimal cut. The higher initial potential, the more probability target min-cut.

Due to the proposed new method ENISLE is different with any other mincut partitioning methods, not improve or modify other min-cut partitioning methods. So the present invention does not concentrate on the comparisons with them, mainly focus on the demonstration of the proposed new method. Vertex (node) min-cut also can be implemented by the proposed method, only add a transform step:

G=(V, E)→(E, V)=(V′, E′)=F

The proposed work can get the minimal edge cuts of the network netlists F, and these are the minimal node cuts of the original network G. It may be useful on the network flow problems. The present invention indicates that we can effectively solve the min-cut partitioning and the ratio min-cut partition at the same time by global viewpoints. The proposed ENISLE method is not only using node information but also edge information. Hundreds of netlists experiments have ever been processed and found the importance of (V, E) pair distributed condition. If we can let (V, E) pairs approach to uniformly distribution on the V-E plain, we can soon get the optimal solution, no more NP problem. If we can't, or just require certain cuts constraint, not min-cut, our method can provide an intuitive heuristic nearly optimal solution, is very suitable for IC industrial EDA usage.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method of Edge-Node Interleave Sort for Leaching and Envelop (ENISLE), comprising:
mapping a circuit into a V-E plain to transform a circuit information into said V-E plain which contains the information of node and edge information, Wherein said V indicates nodes that represent components of said circuit and wherein said E indicates edges that represents the nets of said circuits;
determining whether V-E pairs distribution on said V-E plain is uniformly or not, if said V-E pairs distribution approaching to non-uniformly distribution, then randomizing said V-E pairs on said V-E plain, otherwise performing following steps for sequentially arranging allocations of the V-E pairs according to the magnitude of each said node or said edge, thereby obtaining min-cut or/and ratio min-cut partitioning;
performing a first sorting step from an edge view based on a first side of said V-E plain;
performing a second sorting step from an node view based on a second side of said V-E plain;
performing a third sorting from said edge view based on a third side of said V-E plain; and
performing a fourth sorting step from said node view based on a fourth side of said V-E plain.

2. The method of claim 1, wherein said first side refers to a bottom side of said V-E plain.

3. The method of claim 1, wherein said second side refers to a right side of said V-E plain.

4. The method of claim 1, wherein said first side refers to a top side of said V-E plain.

5. The method of claim 1, wherein said first side refers to a left side of said V-E plain.

6. The method of claim 1, further comprising following steps after performing said fourth sorting:
initializing node set record
performing a fifth sorting step from said node view based on the second side;
performing a sixth sorting step from said edge view based on said first side/third side;
determining whether said node set is still interchanged or not? If said node set is no longer interchange then go back to perform said fifth sorting step, otherwise, performing a seventh sorting step from said node view based on said fourth side;
determining whether said node set still interchange or not? If said node set is still interchange, then performing said fifth sorting step for achieving an optimal min-cut or ratio min-cut partitioning.

7. The method of claim 6, wherein said first side refers to a bottom side of said V-E plain.

8. The method of claim 6, wherein said second side refers to a right side of said V-E plain.

9. The method of claim 6, wherein said first side refers to a top side of said V-E plain.

10. The method of claim 6, wherein said first side refers to a left side of said V-E plain.

11. A method for min-cut and/or ratio min-cut partitioning, comprising:
mapping a circuit into a V-E plain to transform a circuit information into said V-E plain which contains the information of node and edge information, Wherein said V indicates nodes that represent components of said circuit and wherein said E indicates edges that represents the nets of said circuits;
performing following steps for sequentially arranging allocations of the V-E pairs according to the magnitude of each said node or said edge, thereby obtaining min-cut or/and ratio min-cut partitioning;
performing a first sorting step from an edge view based on a first side of said V-E plain;
performing a second sorting step from an node view based on a second side of said V-E plain;
performing a third sorting from said edge view based on a third side of said V-E plain; and
performing a fourth sorting step from said node view based on a fourth side of said V-E plain.

12. The method of claim 11, further comprising determining whether said V-E pairs distribution on said V-E plain is uniformly or not, if said V-E pairs distribution approaching to non-uniformly distribution, then randomizing said V-E pairs on said V-E plain.

13. The method of claim 11, wherein said first side refers to a bottom side of said V-E plain.

14. The method of claim 11, wherein said second side refers to a right side of said V-E plain.

15. The method of claim 11, wherein said first side refers to a top side of said V-E plain.

16. The method of claim 11, wherein said first side refers to a left side of said V-E plain.

17. A method for min-cut and/or ratio min-cut partitioning, comprising:
mapping a circuit into a V-E plain to transform a circuit information into said V-E plain which contains the information of node and edge information, Wherein said V indicates nodes that represent components of said circuit and wherein said E indicates edges that represents the nets of said circuits;
determining whether V-E pairs distribution on said V-E plain is uniformly or not, if said V-E pairs distribution approaching to non-uniformly distribution, then randomizing said V-E pairs on said V-E plain, otherwise performing following steps for sequentially arranging allocations of the V-E pairs according to the magnitude of each said node or said edge, thereby obtaining min-cut or/and ratio min-cut partitioning;
performing a first sorting step from an edge view based on a first side of said V-E plain;
performing a second sorting step from an node view based on a second side of said V-E plain;
performing a third sorting from said edge view based on a third side of said V-E plain;
performing a fourth sorting step from said node view based on a fourth side of said V-E plain;
initializing node set record;
performing a fifth sorting step from said node view based on the second side;
performing a sixth sorting step from said edge view based on said first side/third side;
determining whether said node set is still interchanged or not? If said node set is no longer interchange then go back to perform said fifth sorting step, otherwise, performing a seventh sorting step from said node view based on said fourth side;
determining whether said node set still interchange or not? If said node set is still interchange, then performing said fifth sorting step for achieving an optimal min-cut or ratio min-cut partitioning.

18. A method for display data compression techniques by different light intensity and/or different patterns on a monochrome viewpoint, comprising:
displaying (V, E) pairs on an initial V-E plain shown on a monitor screen to observe the said initial (V, E) pairs distributed condition, wherein said V indicates nodes that represent components of said circuit and wherein said E indicates edges that represents the nets of said circuits;
setting L nodes×W edges (V, E) pairs rectangle region to compose a block, wherein said L and W are integers;
defining the more (V, E) pairs in said block to be displayed by the relatively high light intensity to the less (V, E) pairs in said block; and
watching relatively large size of V-E plain or a whole V-E plain to said initial (V, E) plain on said monitor screen, wherein said exact (V, E) pairs positions still be held, thereby zooming in said V-E plain to watch detail local (V, E) pairs distributed condition, or zooming out to watch global (V, E) pairs distributed condition on said monitor screen.

19. A method for display data compression techniques by different light intensity and/or different patterns on a monochrome viewpoint, comprising:
displaying (V, E) pairs on an initial V-E plain shown on a monitor screen to observe the said initial (V, E) pairs distributed condition, wherein said V indicates nodes that represent components of said circuit and wherein said E indicates edges that represents the nets of said circuits;
setting L nodes×W edges (V, E) pairs rectangle region to compose a block, wherein said L and W are integers;
defining the less (V, E) pairs in said block to be displayed by the relatively high light intensity to the more (V, E) pairs in said block; and
watching relatively large size of V-E plain or a whole V-E plain to said initial (V, E) plain on said monitor screen, wherein said exact (V, E) pairs positions still be held, thereby zooming in said V-E plain to watch detail local (V, E) pairs distributed condition, or zooming out to watch global (V, E) pairs distributed condition on said monitor screen.

20. A method for display data compression techniques by different color and/or different patterns on a monochrome viewpoint, comprising:
displaying (V, E) pairs on an initial V-E plain shown on a monitor screen to observe the said initial (V, E) pairs distributed condition, wherein said V indicates nodes that represent components of said circuit and wherein said E indicates edges that represents the nets of said circuits;
setting L nodes×W edges (V, E) pairs rectangle region to compose a block, wherein said L and W are integers;
defining the more (V, E) pairs in said block to be displayed by the relatively bright color to the less (V, E) pairs in said block; and
watching relatively large size of V-E plain or a whole V-E plain to said initial (V, E) plain on said monitor screen, wherein said exact (V, E) pairs positions still be held, thereby zooming in said V-E plain to watch detail local (V, E) pairs distributed condition, or zooming out to watch global (V, E) pairs distributed condition on said monitor screen.

21. A method for display data compression techniques by different color and/or different patterns on a monochrome viewpoint, comprising:
displaying (V, E) pairs on an initial V-E plain shown on a monitor screen to observe the said initial (V, E) pairs distributed condition, wherein said V indicates nodes that represent components of said circuit and wherein said E indicates edges that represents the nets of said circuits;
setting L nodes×W edges (V, E) pairs rectangle region to compose a block, wherein said L and W are integers;
defining the more (V, E) pairs in said block to be displayed by the relatively bright color to the less (V, E) pairs in said block; and
watching relatively large size of V-E plain or a whole V-E plain to said initial (V, E) plain on said monitor screen, wherein said exact (V, E) pairs positions still be held, thereby zooming in said V-E plain to watch detail local (V, E) pairs distributed condition; or zooming out to watch global (V, E) pairs distributed condition on said monitor screen.
